(19) United States
(12) Patent Application Publication
(10) Pub. No.: US 2018/0262899 A1
(43) Pub. Date: Sep. 13, 2018

(54) WIRELESS COMMUNICATION APPARATUS AND CONTROL METHOD THEREOF

(71) Applicant: CANON KABUSHIKI KAISHA, Tokyo (JP)

(72) Inventor: Tomokazu YAMAKI, Kawasaki-shi (JP)

(21) Appl. No.: 15/541,172

(22) PCT Filed: Feb. 8, 2016
(86) PCT No.: PCT/JP2016/000630

§ 371 Date: Jun. 30, 2017

(30) Foreign Application Priority Data
Feb. 23, 2015 (JP) 2015-033193

(51) Int. Cl. H04W 8/00; H04W 48/14; H04W 48/16; H04W 76/10

(52) U.S. Cl. CPC H04W 8/005; H04W 48/14; H04W 84/12; H04W 76/10; H04W 48/16

(57) ABSTRACT

In order to provide a technique capable of more preferable wireless communication connection, a wireless communication apparatus transmits a probe request signal containing a predetermined information element; receives, from another wireless communication apparatus, a response signal to the probe request signal; obtains, from the other wireless communication apparatus, characteristic information indicating a communication characteristic of a wireless LAN in the infrastructure mode to which the other wireless communication apparatus is connected; and selects, based on the characteristic information, communicating with the other wireless communication apparatus via the wireless LAN in the infrastructure mode or directly communicating with the other wireless communication apparatus without going through the wireless LAN in the infrastructure mode.

### TECHNICAL FIELD

The present invention relates to wireless connection control in a wireless communication apparatus.

### BACKGROUND ART

In recent years, the number of cases in each of which an electronic device such as a digital camera or a printer incorporating a wireless LAN station function is used by connecting it to a wireless LAN access point is increasing. For example, PTL 1. discloses a method of facilitating image sharing by incorporating a wireless communication function in a digital camera.

The Wi-Fi Alliance stipulates a standard called Wi-Fi Direct (R) (to be referred to as WFD hereinafter) which facilitates wireless communication connection between electronic devices each incorporating a wireless LAN function. WFD defines a protocol for deciding whether each electronic device operates as a wireless LAN access point (AP) or a wireless LAN station (STA). It is automatically decided which electronic device serves as the wireless LAN access point and which electronic device serves as the wireless LAN station by executing the protocol, thus improving user convenience. WFD also defines a function (service discovery function) of advertising/searching for service information supported by a host application as an optional function. It is possible to know service information held by an electronic device to be a connection partner before performing connection processing by using the service discovery function, thereby improving user convenience. Note that connection by WFD can be operated concurrently while connecting the electronic device to the wireless LAN access point as the wireless LAN station.

It is possible to search for the electronic device which provides a predetermined service by the above-described service discovery function. However, it is unknown to determine whether the discovered electronic device can be connected to another connection path other than a connection path by WFD. Therefore, service discovery needs to be made separately in the other connection path in order to detect the other connection path. Furthermore, when there exist a plurality of connection paths, it is impossible to determine which connection path is preferable for use.

### CITATION LIST

### Patent Literature

PTL 1: Japanese Patent Laid-Open No. 2011-35768

### SUMMARY OF INVENTION

According to one aspect of the present invention, a wireless communication apparatus, the apparatus comprises: transmission means for transmitting a probe request signal containing a predetermined information element and based on an IEEE802.11 standard; reception means for receiving, from another wireless communication apparatus which operates as a station in an infrastructure mode based on the IEEE802.11 standard, a response signal to the probe request signal transmitted by the transmission means; obtaining means for obtaining, from the other wireless communication apparatus which has transmitted the response signal, characteristic information indicating a communication characteristic of a wireless LAN in the infrastructure mode to which the other wireless communication apparatus is connected; and selection means for selecting, based on the characteristic information obtained by the obtaining means, communicating with the other wireless communication apparatus via the wireless LAN in the infrastructure mode or directly communicating with the other wireless communication apparatus without going through the wireless LAN in the infrastructure mode.

According to another aspect of the present invention, a control method of a wireless communication apparatus, the method comprises: a transmission step of transmitting a probe request signal containing a predetermined information element and based on an IEEE802.11 standard; a reception step of receiving, from another wireless communication apparatus which operates as a station in an infrastructure mode based on the IEEE802.11 standard, a response signal to the probe request signal transmitted in the transmission step; an obtaining step of obtaining, from the other wireless communication apparatus which has transmitted the response signal, characteristic information indicating a communication characteristic of a wireless LAN in the infrastructure mode to which the other wireless communication apparatus is connected; and a selection step of selecting, based on the characteristic information obtained in the obtaining step, communicating with the other wireless communication apparatus via the wireless LAN in the infrastructure mode or directly communicating with the other wireless communication apparatus without going through the wireless LAN in the infrastructure mode.

The present invention allows for more preferable wireless communication connection.

Further features of the present invention will become apparent from the following description of exemplary embodiments (with reference to the attached drawings).

### BRIEF DESCRIPTION OF DRAWINGS

The accompanying drawings, which are incorporated in and constitute a part of the specification, illustrate embodiments of the invention and, together with the description, serve to explain the principles of the invention.

FIG. 1 is a block diagram exemplifying the internal arrangement of a communication apparatus;

FIG. 2 is a block diagram exemplifying a functional block of the communication apparatus;

FIG. 3 is a diagram showing an example of the arrangement of an entire system including the communication apparatus;

FIG. 4 is an operation flowchart of the communication apparatus according to the first embodiment; and

FIG. 5 is an operation sequence chart according to the first embodiment.

### DESCRIPTION OF EMBODIMENTS

A preferred embodiment of the present invention will be described below in detail with reference to the accompanying drawings. Note that the following embodiment is merely an example, and is not intended to limit the scope of the present invention.

### First Embodiment

A communication apparatus 101 which performs communication complying with the IEEE802.11 series standard (to be simply referred to as the IEEE802.11 standard hereinafter) will be exemplified below as a wireless communication apparatus according to the first embodiment of the present invention. A case in which the communication apparatus 101 performs Wi-Fi Direct (WFD) connection to another communication device operating as a station (STA) will specifically be described below. An example in which a wireless LAN system of the 802.11 standard is used will be described below. However, another wireless communication system is also applicable.

Apparatus Arrangement

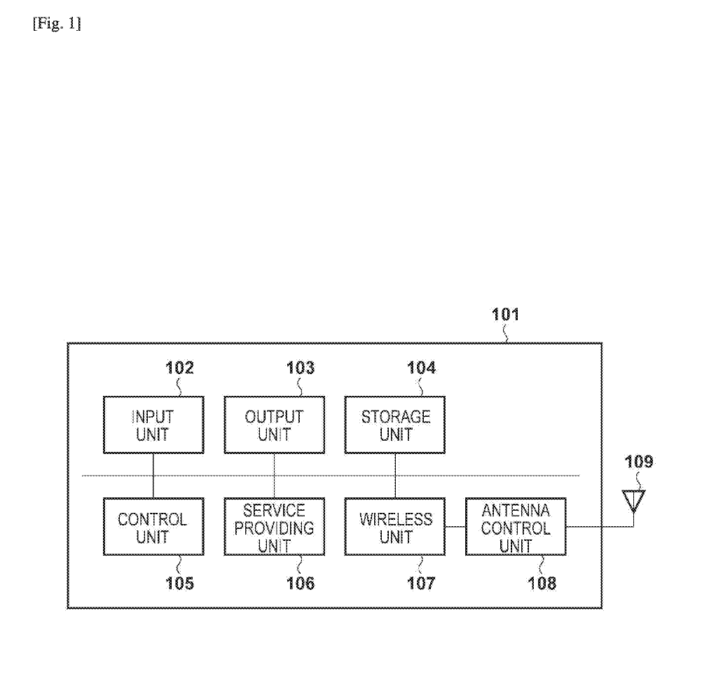

FIG. 1 is a block diagram exemplifying the internal arrangement of the communication apparatus 101.

The communication apparatus 101 includes an input unit 102, an output unit 103, a storage unit 104, a control unit 105, a service providing unit 106, a wireless unit 107, an antenna control unit 108, and an antenna 109.

The input unit 102 is a functional unit configured to accept various inputs for operating the communication apparatus from a user, and is constituted by a button, a switch, a keyboard, a touch panel, and the like.

The output unit 103 is a functional unit which performs various kinds of display and outputs visually recognizable information using an LCD, an LED, or the like. The output unit 103 outputs, for example, various kinds of information such as the operation result of an application. Note that the output unit 103 may also include a loudspeaker or the like that can output sound.

The storage unit 104 is a storage medium such as an HDD, a flash memory, a detachable SD card, or the like. The storage unit 104 is used, for example, to store various kinds of information such as a communication parameter and a program executed by the control unit 105, and to temporarily save a work memory and data when executing the program.

The control unit 105 is, for example, a CPU, executes the program stored in the storage unit 104, and controls the respective functional units of the communication apparatus 101. The control unit 105 also performs setting control of the communication parameter with another apparatus (an opposing apparatus or an access point).

The service providing unit 106 has a function of providing service information at an application level provided by the communication apparatus 101. Note that services include a client service which uses the function of a partner communication apparatus and a server service which provides the function of a self apparatus to the partner communication apparatus. For example, when the communication apparatus 101 is a printer, the server service of a printing function is provided to an external device. When the communication apparatus 101 is a digital camera, the server service of an image capturing function is provided to the external device, or the client service which uses a display function or a storage function provided by the partner communication apparatus is provided.

The wireless unit 107 serving as a wireless communication unit performs wireless

LAN communication complying with the IEEE802.11 standard. Note that wireless LAN communication is performed via the antenna control unit 108 and the antenna 109. Note that another communication system such as Bluetooth (R) or Zigbee (R) may be used for wireless communication.

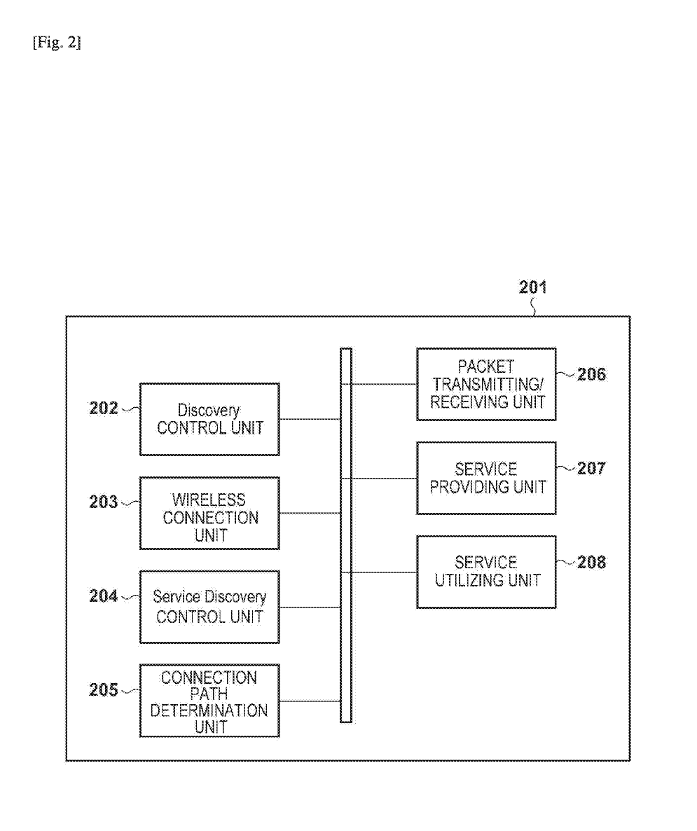

FIG. 2 is a block diagram exemplifying a functional block 201 of the communication apparatus 101. Each function below is implemented by causing the control unit 105 to execute a control program stored in the storage unit 104.

A Discovery control unit 202 is a functional unit which operates device search processing of discovering (searching for) a communication apparatus to be a communication partner and an access point (AP). A case in which a Probe_Request signal/Probe_Response signal of the IEEE802.11 series is used will be described here. However, the present invention is not limited to this. For example, discovery may be made by receiving a Beacon signal transmitted from the opposing apparatus or the AP. Further, an action frame defined in the IEEE802.11u may be used. Furthermore, the opposing apparatus or the AP may be discovered by a different communication system such as NFC (Near Field Communication) or Bluetooth (R).

A wireless connection unit 203 is a functional unit configured to perform wireless communication with the opposing apparatus or the AP discovered by the Discovery control unit 202. In an infrastructure mode of a wireless LAN, Authentication, Association, and the like are performed, thereby implementing wireless LAN connection. In WFD, connection is implemented based on a WFD protocol specification.

In a WFD standard, a communication apparatus which executes a wireless LAN access point function will be called a P2P group owner (to be referred to as GO hereinafter) and a communication apparatus which executes a wireless LAN station function will be called a P2P client (to be referred to as CL hereinafter). These roles are decided by a protocol of a GO negotiation and defined by the Wi-Fi Direct standard. In Wi-Fi Direct, a network established by the GO will be called a P2P group. Note that communication apparatuses of the P2P group (a device which operates as the GO, a device which operates as the CL, and a device which is undecided whether to operate as the GO or the CL though Wi-Fi Direct is activated) will collectively be called P2P devices hereinafter.

A Service Discovery control unit 204 conducts a Service Discovery (SD) function defined in Wi-Fi Direct. The Service Discovery function exchanges possessed service information with the partner communication apparatus by transmitting/receiving the action frame defined in the IEEE802.11u.

More specifically, the Service Discovery function transmits an SD_Query signal to the partner communication apparatus and receives an SD_Response signal from the partner communication apparatus as a response. Alternatively, the Service Discovery function receives the SD_Query signal from the partner communication apparatus and transmits the SD_Response signal to the partner communication apparatus as a response signal. Service information exchanged here contains the following contents:
protocol information used to mutually perform service communication; and
service function compatibility information indicating the compatibility of an essential function or an optional function of a service (for example, in the case of a printer, a double-sided printing compatibility, a color or monochrome printing compatibility, and a format printing compatibility).

Of course, information described above is merely an example and other information. may be contained.

A connection path determination unit 205 is a functional unit which selects a suitable connection path on reflection of information regarding the communication characteristics, connection information, and a desire for connection of the opposing apparatus as well as a user intention. Note that the user intention may be prestored as a set value or configured such that designation from the user may be accepted through a displayed GUI screen.

A packet transmitting/receiving unit 206 manages transmission/reception of a packet including a communication protocol of an upper layer.

A service providing unit 207 is a functional unit which provides a service in an application layer. The application layer here refers to a service providing layer in the upper layer of the fifth or higher layer in an OSI reference model. That is, the service providing unit 207 provides a printing service, a moving image streaming service, a file transfer service, and the like.

A service utilizing unit 208 is a functional unit which utilizes the service in the application layer. More specifically, the service utilizing unit 208 utilizes the service from the service providing unit in the application layer of the partner communication apparatus. That is, the service includes a function of transmitting print data to a printing service providing apparatus and a function of transmitting moving image data to a digital display.

Note that the above-described functional block arrangement is merely an example. For example, the plurality of functional blocks shown in FIG. 2 may be arranged as one functional block or one functional block of FIG. 2 may have a plurality of functions.

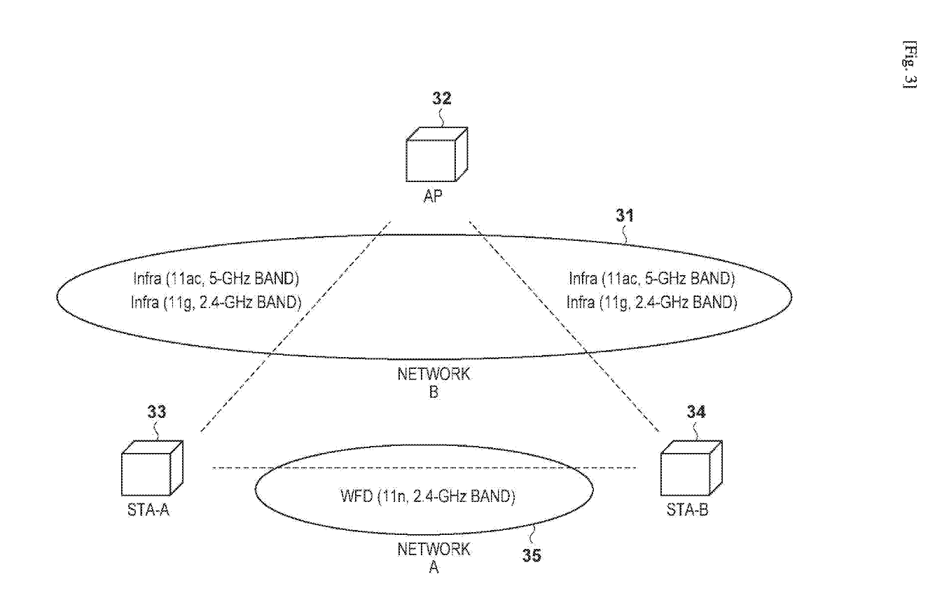

FIG. 3 is a diagram showing an example of the arrangement of an entire system including the communication apparatus. The arrangement including an STA-A 33 and an STA-B 34 is shown here. Note that each of the STA-A 33 and the STA-B 34 has the arrangement of the communication apparatus 101 that has been described with reference to FIGS. 1 and 2.

A network A 35 indicates a network by WFD connection by the IEEE802.11n (2.4-GHz band). On the other hand, a network B 31 indicates a network in a wireless LAN infrastructure mode (to be referred to as Infra hereinafter) by the IEEE802.11ac (5-GHz band) and the IEEE802.11g (2.4-GHz band).

A wireless LAN access point 32 (to be referred to as the AP 32 hereinafter) operates as an access point (base station apparatus) which operates in the infrastructure mode in accordance with the IEEE802.11 standard. As described above, the AP 32 establishes the network B 31 serving as the wireless network and broadcasts/transmits the Beacon signal (broadcast signal) periodically.

Apparatus Operation

Service search processing and a connection processing operation in a wireless LAN layer when executing a service such as printing or video streaming will be described below.

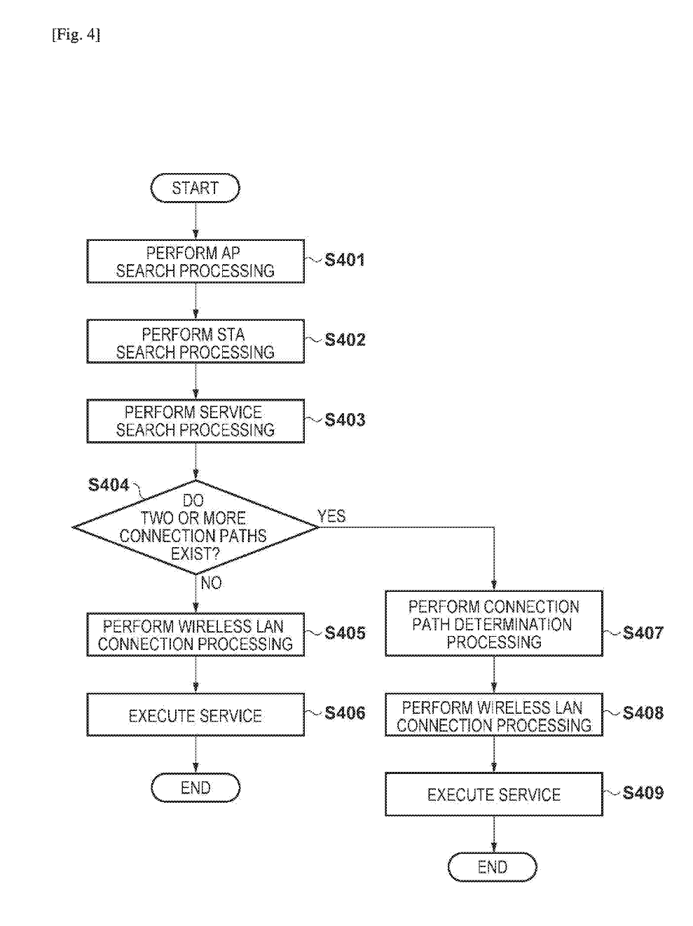

FIG. 4 is an operation flowchart of the communication apparatus according to the first embodiment. More specifically, FIG. 4 shows an operation flowchart of the STA-A 33 serving as a service utilizing apparatus. The operation is started when, for example, a user of the STA-A 33 utilizes the service of a service providing apparatus (STA-B 34) by operating the input unit 102 or the like.

Note that in the printing service, the service utilizing apparatus is an apparatus such as a digital camera or a smartphone having image data and document data serving as print targets. On the other hand, in the printing service, the service providing apparatus is an apparatus such as a printer having the printing function.

In the moving image streaming service, the service utilizing apparatus is an image capturing apparatus such as a digital camera or a camcorder and the service providing apparatus is an image display apparatus such as a TV set or a projector.

Furthermore, when a service to be used is a content distribution service complying with a DLNA (R) standard, the service utilizing apparatus is a DMS (Digital Media Server) and the service providing apparatus is a DMR (Digital Media Renderer).

In step S401, the STA-A 33 performs search processing of one or more wirelessly connectable APs. In AP search processing, the Discovery control unit 202 transmits/receives the Probe_Request signal/Probe_Response signal via the packet transmitting/receiving unit 206. When connection is made in an. Infra form, the AP that has been. discovered in this AP search processing is used. Note that with a general wireless LAN product which is currently deployed on a market, these Probe_Request signal/Probe_Response signal are transmitted/received individually for each frequency band/channel.

In step S402, the STA-A 33 performs STA search processing. In STA search processing, the Discovery control unit 202 transmits/receives the Probe_Request signal/Probe_Response signal via the packet transmitting/receiving unit 206, as in step S401.

Note that additional information can be added, as an Information Element (IE), to the Probe_Request signal/Probe_Response signal. This allows the STA-A 33 to determine, based on the presence or absence of the IE or a content (providing enable/disable information), whether a response comes from a partner that can provide a desirable service. For example, it is possible to know whether the partner can be connected by Wi-Fi. Direct. It is also possible to contain a service type to be utilized in the Probe-Request signal, and to receive the Probe_Response signal only from an opposing communication apparatus corresponding to that service type. Note that the service type can be anything such as a hash value that can specify the service. When connection is made in a WFD form to be described later, direct connection (direct connection path) with the communication apparatus discovered in step S402 is made.

In step S403, the STA-A 33 performs service search processing (service discovery). In service search processing, the Service Discovery control unit 204 transmits/receives, via the packet transmitting/receiving unit 206, the SD_Query signal serving as a search signal and the SD_Response signal serving as the response signal for the communication apparatus detected in step S402. This makes it possible to decide service detailed information with the opposing apparatus.

The SD_Response signal contains the communication characteristics of the opposing apparatus and joined (connected) AP identification information (for example, an SSID and a MAC address). The SD_Response signal may further contain desire-for-connection information indicating whether the opposing apparatus desires connection. Note that it is possible to prevent a discovery failure of the connection path by containing all the communication characteristics (2.4-GHz and 5-GHz communication characteristics here) of the opposing apparatus in the SD_Response signal and obtaining them in step S403 even if processing in step S401 is perforated only in a certain frequency band.

However, at least one of the communication characteristics of the opposing apparatus, connected AP identification information, and the desire for connection of the opposing apparatus suffices to be obtained in step S401. In this case, however, processing in step S401 needs to be performed by the count corresponding to the number of frequency hands because information is to be obtained with respect to only the frequency band that has undergone processing in step S401. Note that information may be obtained by performing AP search processing in step S401. on a plurality of frequency bands only once.

In step S404, the STA-A 33 checks whether a plurality of (two or more) connection paths exist with respect to the opposing apparatus serving as the service providing apparatus specified in step S403. More specifically, the STA-A 33 determines whether the other connection path different from the connection path by WFD with respect to the STA-B 34 detected in step S403 exists.

For example, in step S403, AP identification information to which the STAB 34 serving as the opposing apparatus is connected is found from information contained in the SD_Response signal. It is therefore possible to determine that a connection path by the same Infra exists if the same identification information as the above-described AP identification information detected in step S401 is contained. If there are two or more connection paths to the opposing apparatus (Yes in step S404), the process advances to step S407. On the other hand, if there is only one connection path to the opposing apparatus (No in step S404), the process advances to step S405.

In step S405, the STA-A 33 performs wireless LAN connection processing in the wireless connection unit 203 and the packet transmitting/receiving unit 206. In step S406, a service is started.

In step S407, the STA-A 33 performs connection path determination processing. For example, the following can be used as criteria when making determination:

1) communication characteristics;

2) service type to be utilized;

3) desire-for-connection information of a communication partner; and

4) service practicability in Peer-To-Peer.

An example of the criterion 1) includes the following. For example, a faster path is selected preferentially (the IEEE802.11ac is selected when comparing the IEEE802.11ac with the IEEE802.11n). Alternatively, a path higher in a radio field intensity is selected preferentially, or a path lower the degree of noise is selected preferentially.

An example of the criterion 2) includes the following. For example, in a service which requires cooperation with another system such as a cloud service, the connection path of the infra is preferentially selected. On the other hand, in a service such as the moving image streaming service which handles a large amount of data, a connection path of WFD for reducing the use band of a wireless line is preferentially selected.

An example of the criterion 3) includes the following. For example, a path (information on the path for which connection is desired) acquired in the SD_Response signal for which the opposing apparatus desires connection is selected. This means that, for example, an Infra path is designated for the opposing apparatus to achieve power saving.

The determination criterion out of these criteria to be used by the STA-A 33 serving as the service utilizing apparatus can be set arbitrarily. For example, prior to performing processing in step S407, the determination criterion for use may be accepted from the user via the input unit 102. Alternatively, the determination criterion for use may be accepted from the user in advance and its contents may be saved in the storage unit 104 for reference.

At the time of performing processing in step S407, the communication characteristics of the opposing apparatus, the AP connectable to the opposing apparatus, the desire for connection of the opposing apparatus, and the like may be displayed to the output unit 103 to cause the user to select a connection partner via the input unit 102.

An example of the criterion 4) includes the following. For example, when the AP of the connected Infra path is a base station of a public wireless LAN, only communication via the cloud service or the like may be possible. In this case, the Infra path is not suitable as the connection path where the service is executed. Therefore, control of excluding the Infra path from the count of connection paths is executed in step S404 to make narrowing-down determination in consideration of the practicability of service execution as well at an early stage.

Note that desire-for-connection information of the opposing apparatus of 3) may be obtained in, for example, AP search processing (step S401) or STA search processing (step S402).

Note that one path is not necessarily selected. For example, a plurality of connection paths may be selected and the ratio of a data amount or the like to be flowed in the plurality of connection paths may be decided.

In step S408, the STA-A 33 performs wireless connection processing based on the connection path decided in step S407. There are connection by WFD and connection by the Infra here. In the case of WFD connection, the P2P group is formed in accordance with a WFD specification, and the service providing apparatus and the service utilizing apparatus establish connection in a wireless LAN layer and an IP layer. In the case of Infra connection, Authentication, Association, and the like are performed, thereby establishing connection in the wireless LAN layer and also connection in the IP layer with the AP.

In step S406, the STA-A 33 starts a service based on service detailed information obtained in service search processing (step S403) once connection is established.

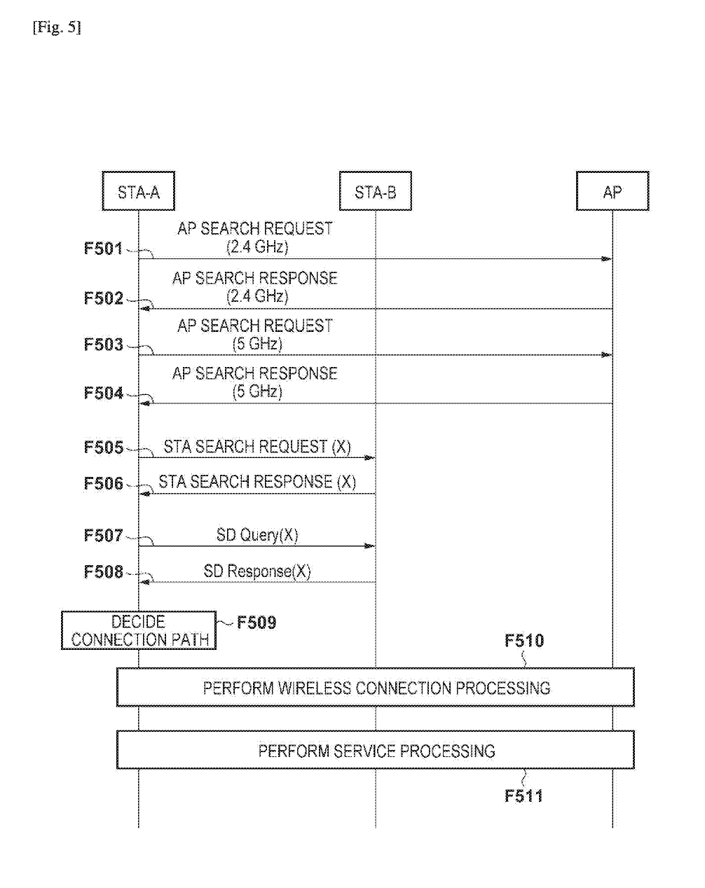

FIG. 5 is an operation sequence chart according to the first embodiment. More specifically, FIG. 5 is a schematic view showing an operation sequence among the respective apparatuses of the AP 32, the STA-A 33, and the STA-B 34. As in the description with reference to FIG. 4, the STA-B 34 is the service providing apparatus, the STA-A 33 is the service utilizing apparatus, and the AP 32 is the access point which establishes an Infra network. The STA-B 34 serving as the service providing apparatus is an apparatus that can provide a predetermined service (to be referred to as a “service X” hereinafter).

The STA-A 33 causes the Discovery control unit 202 to transmit an AP search request via the packet transmitting/receiving unit 206 in order to perform AP search processing (F501). The AP search request here is the Probe-Request signal in the 2.4-GHz band. The AP capable of communication in the 2.4-GHz band can be discovered by this request.

Upon receiving the AP search request, the AP 32 transmits an AP search response (F502). The AP search response here is the Probe_Response signal in the 2.4-GHz band. The STA-A 33 discovers the AP 32 capable of communication in the 2.4-GHz band by this response.

The STA-A 33 causes the Discovery control unit 202 to transmit an AP search request via the packet transmitting/receiving unit 206 in order to perform AP search processing (F503). The AP search request here is the Probe-Request signal in the 5-GHz band. The AP capable of communication in the 5-GHz band can be discovered by this request.

Upon receiving the AP search request, the AP 32 transmits an AP search response (F504). The AP search response here is the Probe_Response signal in the 5-GHz band. The STA-A 33 discovers the AP 32 capable of communication in the 5-GHz band by this response. When connection is made by the Infra, the AP 32 discovered in the network B 31 is used.

The STA-A 33 causes the Discovery control unit 202 to transmit an STA search request via the packet transmitting/receiving unit 206 in order to perform STA search processing (F505). The STA search request here is the Probe-Request signal. A P2P device can be discovered by this request. The Probe_Request signal can contain the service type to be utilized and the Probe_Response signal can be received only from the P2P device corresponding to that service type. Here, the Probe_Request signal contains the service type of the “service X”.

Upon receiving the STA search request, the STA-B 34 transmits an STA search response (F506). The STA search response here is transmitted only when the response corresponds to the “service X”. When connection is made by WFD, the STA-B 34 found in the network A 35 is used.

The STA-A 33 starts service search processing of the “service X”. More specifically, the STA-A 33 causes the Service Discovery control unit 204 to transmit the SD_Query signal via the packet transmitting/receiving unit 206 (F507). In this example, the Service Discovery control unit 204 transmits a packet containing information that an apparatus which provides the “service X” is searched for. Note that the SD_Query signal can be unicasted, or can be broadcast or multicasted.

Upon receiving the SD_Query signal, the STA-B 34 transmits the SD_Response signal indicating that the “service X” can be provided to the STA-A 33 (F508). In FIG. 5, the SD_Response signal contains the communication characteristics of the STA-B 34 in 2.4 GHz and 5 GHz, and joined (connected) AP identification information (for example, the SSID and the MAC address) of the AP 32. The SD_Response signal does not contain desire-for-connection information of the STA-B 34.

For example, the types of standards such as the IEEE802.11g, the IEEE802.11ac, and the IEEE802.11n, the radio field intensity, and noise are considered as the communication characteristics. In F507 to F508, service detailed information of the “service X” can be decided. Service detailed information contains protocol information and function compatibility information. However, a description thereof will be omitted because it has already been given above.

Since there exist three connection paths to the STA-B 34, the STA-A 33 decides the connection path (F509). That is, the three connection paths of the “network B 31 (the IEEE802.11ac of the Infra)”, the “network B 31 (the IEEE802.11g of the Infra)”, and the “network A 35 (the IEEE802.11n of WFD)” exist. The connection path is decided by selecting the determination criteria such as 1) the communication characteristics, 2) the service type to be utilized, and 3) desire-for-connection information of the communication partner, as described above.

In FIG. 5, determination is made based on the communication characteristics. For example, the connection path in the fastest “network B 31 (the IEEE802.11ac of the Infra)” is selected.

The STA-A 33 performs wireless connection processing on the connection path decided in F509 (F510). This processing sets the STA-A 33 and the STA-B 34 in a state capable of communication via the AP 32.

Once wireless connection processing is completed, the STA-A 33 starts the “service X” based on service information obtained by service search (F511).

The above-described operation is performed, for example, in a case in which if the STA-A 33 is a camera terminal and the STA-B 34 is a display, a display device that can display a captured moving image is searched for to perform display processing wirelessly when playing back that moving image. Alternatively, the above-described operation is performed in a case in which if the STA-A 33 is a digital camera and the STA-B 34 is a printer, a printer having a printing function is searched for to perform print processing wirelessly when printing a captured image.

As described above, according to the first embodiment, more preferable wireless communication connection can be performed when searching for and connecting to a providing apparatus which provides a predetermined service. For example, when a plurality of connection paths exist for the providing apparatus, it is possible to reduce a decrease in throughput or the like caused by an inappropriate connection path and to improve user convenience.

The embodiment complying with the wireless LAN (WLAN) of the IEEE802.11 standard has been described above. However, changes can be made without departing from a technical scope. A processing order in the flowchart can also be changed as long as described execution contents can be achieved.

The communication apparatus of the above-described embodiment is not limited to the digital camera or the printer but may be, for example, a PC, a tablet terminal, or a wearable terminal. Alternatively, the communication apparatus of the above-described embodiment may be a mobile terminal such as a cellular phone or a smartphone, or may be an image processing apparatus such as a copying machine or a multifunction peripheral, or a digital appliance such as a TV set or a recorder.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-033193, filed Feb. 23, 2015 which is hereby incorporated by reference herein in its entirety.

1. A wireless communication apparatus, the apparatus comprising:
a transmission unit configured to transmit a probe request signal containing a predetermined information element and based on an IEEE802.11 standard;
a reception unit configured to receive, from another wireless communication apparatus which operates as a station in an infrastructure mode based on the IEEE802.11 standard, a response signal to the probe request signal transmitted by the transmission unit;
an obtaining unit configured to obtain, from the other wireless communication apparatus which has transmitted the response signal, characteristic information indicating a communication characteristic of a wireless LAN in the infrastructure mode to which the other wireless communication apparatus is connected; and
a selection unit configured to select, based on the characteristic information obtained by the obtaining unit, either communicating with the other wireless communication apparatus via the wireless LAN in the infrastructure mode or directly communicating with the other wireless communication apparatus without going through the wireless LAN in the infrastructure mode.

2. The apparatus according to claim 1, wherein the response signal contains AP identification information of the wireless LAN.

3. The apparatus according to claim 1, wherein when the selection unit selects direct communication, the other wireless communication apparatus is connected in accordance with a Wi-Fi Direct (WFD) standard.

4. The apparatus according to claim 1, wherein the predetermined information element is an information element concerning whether connection in accordance with the Wi-Fi Direct (WFD) standard is possible.

5. The apparatus according to claim 1, wherein the response signal contains indication information indicating a communication method desired by the other wireless communication apparatus, and
the selection unit selects, further based on the indication information, either communicating with the other wireless communication apparatus via the wireless LAN in the infrastructure mode or directly communicating with the other wireless communication apparatus without going through the wireless LAN in the infrastructure mode.

6. The apparatus according to claim 1, wherein the characteristic information contains information indicating a type of the IEEE802.11 standard or information on a radio field intensity.

7. A control method of a wireless communication apparatus, the method comprising:
transmitting a probe request signal containing a predetermined information element and based on an IEEE802.11 standard;
receiving, from another wireless communication apparatus which operates as a station in an infrastructure mode based on the IEEE802.11 standard, a response signal to the transmitted probe request signal transmitted in the transmission step;
obtaining, from the other wireless communication apparatus which has transmitted the response signal, characteristic information indicating a communication characteristic of a wireless LAN in the infrastructure mode to which the other wireless communication apparatus is connected; and
selecting, based on the obtained characteristic information, either communicating with the other wireless communication apparatus via the wireless LAN in the infrastructure mode or directly communicating with the other wireless communication apparatus without going through the wireless LAN in the infrastructure mode.

8. A non-transitory computer-readable recording medium storing a computer program for causing, by being executed by a computer including a wireless communication unit, the computer to function as:
a transmission unit configured to transmit a probe request signal containing a predetermined information element and based on an IEEE802.11 standard;
a reception unit configured to receive, from another wireless communication apparatus which operates as a station in an infrastructure mode based on the IEEE802.11 standard, a response signal to the probe request signal transmitted by the transmission unit;
an obtaining unit configured to obtain, from the other wireless communication apparatus which has transmitted the response signal, characteristic information indicating a communication characteristic of a wireless LAN in the infrastructure mode to which the other wireless communication apparatus is connected; and
a selection unit configured to select, based on the characteristic information obtained by the obtaining unit, either communicating with the other wireless communication apparatus via the wireless LAN in the infrastructure mode or directly communicating with the other wireless communication apparatus without going through the wireless LAN in the infrastructure mode.
